(19) United States
(12) Patent Application Publication
(10) Pub. No.: US 2008/0254303 A1
(43) Pub. Date: Oct. 16, 2008

(54) MONOMER MATT ADDITIVES AND USES THEREOF

(75) Inventor: Sally Judith Weine RAMSEY, Tallmadege, OH (US)

Correspondence Address: WILSON SONSINI GOODRICH & ROSATI, 650 PAGE MILL ROAD, PALO ALTO, CA, 94304-1050, US

(73) Assignee: ECOLOGY COATINGS, INC., Akron, OH (US)

(21) Appl. No.: 11/733,742

(22) Filed: Apr. 10, 2007

(51) Int. Cl. C01B 33/12; B32B 9/04

(52) U.S. Cl. 428/447; 106/287.26; 106/287.34

(57) ABSTRACT

Disclosed are monomer matt additives that include actinic-radiation curable monomers and between about 10% and about 40% by weight of amorphous silica. Also disclosed are methods for producing the monomer matt additives. Further disclosed are uses of the monomer matt additives in forming actinic-radiation curable, substantially all solids coating compositions that form a matt coating upon curing. Such coating compositions can be used to coat a variety of surfaces, including wood surfaces, metal surfaces, plastic surfaces and composite surfaces.

### BACKGROUND OF THE INVENTION

In a matt coating, only a portion of the light falling on a surface is directly reflected, the rest of the light is internally scattered. As a result, a surface with a matt coating has a less glossy or shiny appearance. The typical way to produce such a coating is to disperse a matting additive in a solvent-based paint. Upon drying and evaporation of the solvent, the viscosity of the coating increases, this in turn distributes the matting additive evenly throughout the whole film. The shrinking of the coating is thought to be the principle reason for creating the micro rough surface of a matted paint film. Actinic radiation curable, substantially all solids compositions are considered exceptionally difficult to matt because such systems show nearly no shrinkage upon curing.

### SUMMARY OF THE INVENTION

Presented herein are monomer matt additives for use in actinic radiation curable, substantially all solids compositions. Also presented herein are methods for producing a monomer matt additive that can be used in actinic radiation curable, substantially all solids compositions. Also presented herein are actinic radiation curable, substantially all solids compositions containing a monomer matt additive, wherein such actinic radiation curable, substantially all solids compositions upon curing produce a matt coating. Also presented herein are methods for producing or making actinic radiation curable, substantially all solids compositions containing a monomer matt additive, wherein such actinic radiation curable, substantially all solids compositions upon curing produce a matt coating. Also presented herein are articles of manufacture that are at least partially coated with a cured matt coating described herein.

Presented herein are monomer matt additives comprising a dispersion of about 10 wt-% to about 40 wt-% of amorphous silica and at least one monomer. In one embodiment, the monomer polymerizes upon curing with actinic radiation. In one embodiment, the dispersion has essentially no solvent. In a further or alternative embodiment, the dispersion is formed by at least one mixing cycle comprising an ultrasonic mixing step and a mechanical mixing step. In a further or alternative embodiment, the at least one mixing cycle is a first ultrasonic mixing step and a second mechanical mixing step. In a further or alternative embodiment, the at least one mixing cycle is a first mechanical mixing step and a second ultrasonic mixing step.

In a further or alternative embodiment, the dispersion is formed from at least two mixing cycles, from at least three mixing cycles, from at least four mixing cycles, or from at least five mixing cycles.

In a further or alternative embodiment, each ultrasonic mixing step lasts at least about 1 minute, at least about 2 minutes, at least about 3 minutes, at least about 4 minutes, at least about 5 minutes, at least about 6 minutes, at least about 7 minutes, at least about 8 minutes, at least about 9 minutes, or at least about 10 minutes.

In a further or alternative embodiment, each mechanical mixing step lasts at least about 1 minute, at least about 2 minutes, at least about 3 minutes, at least about 4 minutes, at least about 5 minutes, at least about 6 minutes, at least about 7 minutes, at least about 8 minutes, at least about 9 minutes, or at least about 10 minutes.

In a further or alternative embodiment, each ultrasonic mixing step lasts at least about 1 minute, and each mechanical mixing step lasts at least about 1 minute. In a further or alternative embodiment, each ultrasonic mixing step lasts at least about 2 minutes, and each mechanical mixing step lasts at least about 2 minutes. In a further or alternative embodiment, each ultrasonic mixing step lasts at least about 4 minute, and each mechanical mixing step lasts at least about 4 minute. In a further or alternative embodiment, each ultrasonic mixing step lasts at least about 5 minute, and each mechanical mixing step lasts at least about 5 minute.

In a further or alternative embodiment, each mechanical mixing step lasts less than about 30 minutes, less than about 25 minutes, less than about 20 minutes, less than about 15 minutes, or less than about 10 minutes.

In a further or alternative embodiment, each ultrasonic mixing step lasts less than about 30 minutes, less than about 25 minutes, less than about 20 minutes, less than about 15 minutes, or less than about 10 minutes.

In a further or alternative embodiment, the at least one monomer is selected from a group consisting of an isobornyl acrylate, a tetrahydrofurfuryl acrylate, butanediol acrylate, 2-phenoxyethyl acrylate, a propoxylated glyceral triacrylate, a 1,6-hexanediol diacrylate, a dipropylene glycol diacrylate, a tripropylene glycol diacrylate, a neopentyl glycol propoxylated diacrylate, a trimethylopropane triacrylate, a trimethylopropane ethoxylate triacrylate, a pentaerythritol alkoxylate tetraacrylate, a dimethylopropane tetraacrylate, and combinations thereof.

In a further or alternative embodiment, the amorphous silica is selected from fumed amorphous silica, fused amorphous silica, gelled amorphous silica or precipitated amorphous silica. In a further or alternative embodiment, the average size of the amorphous silica is less than about 1 micron, less than about 800 nanometer, less than about 700 nanometer, less than about 600 nanometer, less than about 500 nanometer, less than about 400 nanometer, less than about 300 nanometer, less than about 200 nanometer, or less than about 100 nanometer.

In a further or alternative embodiment, the room temperature viscosity of the composition is less than about 500 centipoise, less than about 450 centipoise, less than about 400 centipoise, less than about 350 centipoise, less than about 300 centipoise, less than about 250 centipoise, less than about 200 centipoise, or less than about 150 centipoise.

In another aspect described herein are methods for forming a monomer matt additive comprising mixing about 10 wt-% to about 40 wt-% of amorphous silica in a monomer. In a further embodiment, the mixing comprises at least one ultrasonic mixing step and at least one mechanical mixing step. In a further embodiment, the resulting dispersion has a room temperature viscosity less than about 500 centipoise, less than about 450 centipoise, less than about 400 centipoise, less than about 350 centipoise, less than about 300 centipoise, less than about 250 centipoise, less than about 200 centipoise, or less than about 150 centipoise. In a further or alternative embodiment, the monomer is selected from the group of monomers described above. In a further or alternative embodiment, the amorphous silica is selected from the group of amorphous silicas presented above. In a further or alternative embodiment the time of the ultrasonic and/or mechanical mixing steps are selected from the times presented above.

In another aspect described herein are methods for forming an actinic radiation curable, substantially all solids composition providing a matt finish upon curing comprising substituting any of the monomer matt additives described above for a monomer in a formulation for an actinic radiation curable, substantially all solids composition. In a further or alternative embodiment, the wt-% of the substituted monomer matt additive is essentially the same as the wt-% of the replaced monomer.

In one aspect the actinic radiation curable, substantially all solids compositions described herein are comprised of a mixture of at least one oligomer, at least one monomer matt additive, at least one photoinitiator, and at least one nano-filler, wherein the composition can provide a matt finish, upon curing, on a metal or plastic object. In a further embodiment, the cured composition can provide a flexible, corrosion resistant, abrasion resistant and scratch resistant coating on a metal or plastic object.

In an embodiment of the aforementioned aspect, the actinic radiation curable, substantially all solids composition comprises at least one oligomer or a multiplicity of oligomers present in the mixture between about 15-45% by weight. In a further or alternative embodiment of the above aspect, the actinic radiation curable, substantially all solids composition comprises at least one monomer matt additive present in the mixture between about 25-65% by weight. In further or alternative embodiments, the actinic radiation curable, substantially all solids composition comprises at least one photoinitiator or a multiplicity of photoinitiators present in the mixture between about 2-10% by weight. In a still further or alternate embodiment, the actinic radiation curable, substantially all solids composition comprises at least one nano-filler or a multiplicity of nano-fillers present in the mixture between about 0.1-25% by weight. In further or alternative embodiments of the aforementioned aspect, the actinic radiation curable, substantially all solids composition optionally comprises up to about 5% by weight of a filler or a multiplicity of fillers. In further or alternative embodiments of the aforementioned aspect, the actinic radiation curable, substantially all solids composition optionally comprises up to about 10% by weight of a polymerizable pigment dispersion or a multiplicity of polymerizable pigment dispersions. In still further or alternative embodiments of the aforementioned aspect, the actinic radiation curable, substantially all solids composition mixture comprises 15-45% percent by weight of an oligomer or a multiplicity of oligomers, and 25-65% by weight of a monomer matt additive. In further or alternative embodiments of this aspect, the actinic radiation curable, substantially all solids composition comprises 15-45% percent by weight of an oligomer or a multiplicity of oligomers, 25-65% by weight a monomer matt additive and 2-10% by weight of a photoinitiator or a multiplicity of photoinitiators. In still further or alternative embodiments, the actinic radiation curable, substantially all solids composition comprises 15-45% percent by weight of an oligomer or a multiplicity of oligomers, 25-65% by weight of a monomer matt additive, 2-10% by weight of a photoinitiator or a multiplicity of photoinitiators, and 0.1-25% by weight of a nano-filler or a multiplicity of nano-fillers. In further or alternative embodiments, the actinic radiation curable, substantially all solids comprises 15-45% percent by weight an oligomer or a multiplicity of oligomers, 25-65% by weight of a monomer matt additive, 2-10% by weight of a photoinitiator or a multiplicity of photoinitiators, 0.1-25% by weight of a nano-filler or a multiplicity of nano-fillers, and up to about 5% by weight of a filler or a multiplicity of fillers. In even further or alternative embodiments, the actinic radiation curable, substantially all solids composition comprises 15-45% percent by weight an oligomer or a multiplicity of oligomers, 30-65% by weight of a monomer matt additive, 2-10% by weight of a photoinitiator or a multiplicity of photoinitiators, 0.1-5% by weight of a nano-filler or a multiplicity of nano-fillers, up to about 5% by weight of a filler or a multiplicity of fillers, and up to about 10% by weight of a polymerizable pigment dispersion or a multiplicity of polymerizable pigment dispersions.

Presented herein are environmentally friendly actinic radiation curable, substantially all solids compositions that provide a matt finish coating for thermally sensitive objects which may or may not be rusty. In one embodiment the actinic radiation curable, substantially all solids compositions are comprised of a mixture of oligomers, a monomer matt additive, photoinitiators, co-photoinitiators, fillers, and polymerizable pigment dispersions. In one embodiment of the this aspect, the actinic radiation curable, substantially all solids composition mixture may comprise 25-45% by weight of an oligomer or a multiplicity of oligomers, a monomer matt additive, photoinitiators, co-photoinitiators, fillers, and polymerizable pigment dispersions.

In another embodiment of the above aspect, the actinic radiation curable, substantially all solids composition mixture comprises 45-60% by weight of a monomer matt additive; plus oligomers, photoinitatiors, co-photoinitiators, fillers, and polymerizable pigment dispersions. In a further embodiment of the aforementioned aspect, the actinic radiation curable, substantially all solids composition mixture comprises 2-11% by weight of a photoinitiator or a multiplicity of photoinitiators and co-initiators; plus oligomers, a monomer matt additive, fillers, and polymerizable pigment dispersions. In a still further embodiment of the above aspect, the actinic radiation curable, substantially all solids composition mixture comprises 0.1-3% by weight of a filler or a multiplicity of fillers; plus oligomers, a monomer matt additive, photoinitatiors, co-photoinitiators, and polymerizable pigment dispersions. In yet another embodiment of the aforementioned aspect, the actinic radiation curable, substantially all solids composition mixture comprises 8-12% by weight of a polymerizable pigment dispersion or a multiplicity of polymerizable pigment dispersions; plus oligomers, a, photo monomer matt additive initatiors, co-photoinitiators, and fillers. In an embodiment of the above aspect, the actinic radiation curable, substantially all solids composition comprises 25-45% percent by weight of an oligomer or a multiplicity of oligomers, and 45-60% by weight of a monomer matt additive; plus photoinitatiors, co-photoinitiators, fillers, and polymerizable pigment dispersions. In another embodiment of the aforementioned aspect, the actinic radiation curable, substantially all solids composition comprises 25-45% percent by weight of an oligomer or a multiplicity of oligomers, 45-60% by weight a monomer matt additive and 2-11% by weight of a photoinitiator or a multiplicity of photoinitiators and co-initiators; plus, fillers, and polymerizable pigment dispersions. In a further embodiment of the above aspect, the actinic radiation curable, substantially all solids composition mixture comprises 25-45% percent by weight of an oligomer or a multiplicity of oligomers, 45-60% by weight of a monomer matt additive, 2-11% by weight of a photoinitiator or a multiplicity of photoinitiators and co-initiators and 0.1-3% by weight of a filler or a multiplicity of fillers; plus polymerizable pigment dispersions. In still further embodiment of the aforementioned aspect, the actinic radiation curable, substantially all solids composition mixture comprises 25-45% percent by weight an oligomer or a multiplicity of oligomers, 45-60% by weight of a monomer matt additive, 2-11% by weight of a photoinitiator or a multiplicity of photoinitiators and co-initiators, 0.1-3% by weight of a filler or a multiplicity of fillers, and 8-12% by weight of a polymerizable pigment dispersion or a multiplicity of polymerizable pigment dispersions.

In one aspect the actinic radiation curable, substantially all solids compositions described herein are comprised of a mixture of at least one oligomer, at least one monomer matt additive, at least one photoinitiator, at least one surfactant, at least one nano-filler, optionally at least one filler, and optionally at least one polymerizable pigment dispersion, wherein the composition when cured as a coating on a composite material provides a matt finish coating.

In an embodiment of the aforementioned aspect, the actinic radiation curable, substantially all solids composition comprises at least one oligomer or a multiplicity of oligomers present in the mixture between about 15-40% by weight. In a further or alternative embodiment of the above aspect, the actinic radiation curable, substantially all solids composition comprises at least one monomer matt additive present in the mixture between about 50-60% by weight. In further or alternative embodiments, the actinic radiation curable, substantially all solids composition comprises at least one photoinitiator or a multiplicity of photoinitiators present in the mixture between about 1-10% by weight. In a still further or alternate embodiment, the actinic radiation curable, substantially all solids composition comprises at least one nano-filler or a multiplicity of nano-fillers present in the mixture between about 5-30% by weight. In further or alternative embodiments of the aforementioned aspect, the actinic radiation curable, substantially all solids composition comprises at least one surfactant or a multiplicity of surfactants between about 0.01-2% by weight. In further or alternative embodiments of the aforementioned aspect, the actinic radiation curable, substantially all solids composition optionally comprises up to about 5% by weight of a UV absorber or a multiplicity of UV absorbers. In further or alternative embodiments of the aforementioned aspect, the actinic radiation curable, substantially all solids composition optionally comprises up to about 10% by weight of a polymerizable pigment dispersion or a multiplicity of polymerizable pigment dispersions. In still further or alternative embodiments of the aforementioned aspect, the actinic radiation curable, substantially all solids composition mixture comprises 15-40% percent by weight of an oligomer or a multiplicity of oligomers, and 50-60% by weight of a monomer matt additive. In further or alternative embodiments of this aspect, the actinic radiation curable, substantially all solids composition comprises 15-40% percent by weight of an oligomer or a multiplicity of oligomers, 50-60% by weight a monomer matt additive and 1-10% by weight of a photoinitiator or a multiplicity of photoinitiators. In still further or alternative embodiments, the actinic radiation curable, substantially all solids composition comprises 15-40% percent by weight of an oligomer or a multiplicity of oligomers, 50-60% by weight of a monomer matt additive, 1-10% by weight of a photoinitiator or a multiplicity of photoinitiators, and 5-30% by weight of a nano-filler or a multiplicity of nano-fillers. In further or alternative embodiments, the actinic radiation curable, substantially all solids comprises 15-40% percent by weight an oligomer or a multiplicity of oligomers, 50-60% by weight of a monomer matt additive, 1-10% by weight of a photoinitiator or a multiplicity of photoinitiators, 5-30% by weight of a nano-filler or a multiplicity of nano-fillers, and 0.01-2% by weight of a surfactant or a multiplicity of surfactants. In even further or alternative embodiments, the actinic radiation curable, substantially all solids composition comprises 15-40% percent by weight an oligomer or a multiplicity of oligomers, 50-60% by weight of a monomer matt additive, 1-10% by weight of a photoinitiator or a multiplicity of photoinitiators, 5-30% by weight of a nano-filler or a multiplicity of nano-fillers, 0.01-2% by weight of a surfactant or a multiplicity of surfactants, and up to about 5% by weight of a UV absorber or a multiplicity of UV absorbers. In even further or alternative embodiments, the actinic radiation curable, substantially all solids composition comprises 15-40% percent by weight an oligomer or a multiplicity of oligomers, 50-60% by weight of a monomer matt additive, 1-10% by weight of a photoinitiator or a multiplicity of photoinitiators, 5-30% by weight of a nano-filler or a multiplicity of nano-fillers, 0.01-2% by weight of a surfactant or a multiplicity of surfactants, up to about 5% by weight of a UV absorber or a multiplicity of UV absorbers and up to about 10% by weight of a polymerizable pigment dispersion or a multiplicity of polymerizable pigment dispersions.

In any of the aforementioned compositions, in one embodiment, the room temperature viscosity of the composition is up to about 500 centipoise, up to about 450 centipoise, up to about 400 centipoise, up to about 350 centipoise, up to about 300 centipoise, up to about 250 centipoise, up to about 200 centipoise, up to about 150 centipoise, up to about 100 centipoise.

In further or alternative embodiments of this aspect of any of the aforementioned compositions, the oligomers may be selected from a group consisting of urethane acrylates, aliphatic urethane acrylates, aliphatic urethane triacrylate/monomer blends, aliphatic urethane triacrylates blended with 1,6-hexanediol acrylates, hexafunctional urethane acrylates, siliconized urethane acrylates, aliphatic siliconized urethane acrylates, polyether acrylates, and combinations thereof. In another or alternative embodiments the monomers are selected from a group consisting of trimethylolpropane triacrylates, 2-phenoxyethyl acrylates, isobornyl acrylates, propoxylated glyceryl triacrylates, acrylate ester derivatives, methacrylate ester derivatives, acrylate ester derivatives, tripropylene glycol diacrylate, and combinations thereof.

In still further or alternative embodiments of any of the aforementioned compositions, the photoinitiators may be selected from a group consisting of diphenyl (2, 4, 6-trimethylbenzoyl) phosphine oxide, benzophenone, ESACURE® KTO, IRGACURE® 500, DARACUR® 1173, Lucirin®TPO, 1-hydroxycyclohexyl phenyl ketone, 2-hydroxy-2-methyl-1-phenyl-propan-1-one, 2, 4,6,-trimethylbenzophenone, 4-methylbenzophenone, oligo (2-hydroxy-2-methyl-1-(4-(1-methylvinyl)phenyl)propanone), and combinations thereof. In another or alternative embodiments, the actinic radiation curable, substantially all solids composition further comprises up to about 2% of a co-photoinitiator selected from amine acrylates, thioxanthone, dimethyl ketal, benzyl methyl ketal, and combinations thereof.

In a still further or alternative embodiment of any of the aforementioned compositions, the fillers are selected from a group consisting of amorphous silicon dioxide prepared with polyethylene wax, synthetic amorphous silica with organic surface treatment, IRGANOX®, untreated amorphous silicon dioxide, alkyl quaternary bentonite, colloidal silica, acrylated colloidal silica, alumina, zirconia, zinc oxide, niobia, titania aluminum nitride, silver oxide, cerium oxides, and combinations thereof. Further, the average size of the filler particles is less than 10 micrometers, or less than 5 micrometers, or even less than 1 micrometer.

In further or alternative embodiments of any of the aforementioned compositions, the nano-fillers may be selected from a group consisting of nano-aluminum oxide, nano-silicon dioxide, nano-zirconium oxide, nano-zirconium dioxides, nano-silicon carbide, nano-silicon nitride, nano-sialon, nano-aluminum nitride, nano-bismuth oxide, nano-cerium oxide, nano-copper oxide, nano-iron oxide, nano-nickel titanate, nano-niobium oxide, nano-rare earth oxide, nano-silver oxide, nano-tin oxide, and nano-titanium oxide, and combinations thereof. In addition, the average size of the nano-filler particles is less than 100 nanometers.

In further or alternative embodiments of any of the aforementioned compositions, the polymerizable pigment dispersions are comprised of at least one pigment attached to an activated resin; wherein the activated resin is selected from a group consisting of acrylate resins, methacrylate resins, and vinyl resins, and the pigment is selected from a group consisting of carbon black, rutile titanium dioxide, organic red pigment, phthalo blue pigment, red oxide pigment, isoindoline yellow pigment, phthalo green pigment, quinacridone violet, carbazole violet, masstone black, light lemon yellow oxide, light organic yellow, transparent yellow oxide, diarylide orange, quinacridone red, organic scarlet, light organic red, and deep organic red.

In a further embodiment of any of the aforementioned compositions, the composition can also contain an additional monomer chosen from a group consisting of 2-phenoxyethyl acrylate, isobornyl acrylate, acrylate ester derivatives, methacrylate ester derivatives; trimethylolpropane triacrylate, 2-phenoxyethyl acrylate esters, and cross-linking agents, such as, but not limited to, propoxylated glyceryl triacrylate, tripropylene glycol diacrylate, and mixtures thereof.

In further or alternative embodiments of any of the aforementioned compositions, the coating may be applied to the surface of objects, by way of example only, by means of spraying, brushing, rolling, dipping, blade coating, curtain coating or a combination thereof. Further, the means of spraying includes, but is not limited to, the use of a High Volume Low Pressure (HVLP) spraying systems, air-assisted/airless spraying systems, or electrostatic spraying systems. In further or alternative embodiments, the coating is applied in a single application, or in multiple applications. In further or alternative embodiments, the surfaces of the objects are partially covered by the uncured coating, or in a still further or alternative embodiments, the surfaces of the objects are fully covered by the uncured coating.

In further or alternative embodiments, the coated surfaces objects are partially cured by exposure of uncured coated surfaces to a first source of actinic radiation. In further or alternative embodiments, the coated surfaces of objects are fully cured by exposure of the partially cured coated surface to a second source of actinic radiation, wherein the resulting fully cured coating has a matt finish.

In further or alternative embodiments, the fully cured matt finish coatings are flexible, adherent, hard, corrosion resistant, abrasion resistant, scratch resistant, or any combinations thereof.

In further or alternative embodiments, the actinic radiation is selected from the group consisting of visible radiation, near visible radiation, ultra-violet (UV) radiation, and combinations thereof. Further, the UV radiation is selected from the group consisting of UV-A radiation, UV-B radiation, UV-B radiation, UV-C radiation, UV-D radiation, or combinations thereof.

In further or alternative embodiments, the completely cured coated surface is part of articles of manufacture. In further or alternative embodiments, the articles of manufacture include the completely cured coated surface. In further or alternative embodiments, the article of manufacture coated may be an article of manufacture wherein at least one of its functions would be enhanced or improved by the presence of a matt finish coating which is flexible, adherent, hard, corrosion resistant, abrasion resistant, scratch resistant, or any combinations thereof.

In a further aspect the method for producing the actinic radiation curable, substantially all solids composition involves adding the components, for instance, by way of example only, at least one oligomer, at least one monomer matt additive, at least one photoinitiator, optionally at least one co-photoinitiator, optionally at least one nano-filler, optionally at least one filler, and optionally at least one polymerizable pigment dispersion, and using a means for mixing the components together to form a smooth composition. In further or alternative embodiments, the composition may be mixed in or transferred to a suitable container, such as, but not limited to, a can.

In another aspect are assemblages for coating at least a portion of a surface of objects (by way of example only, metal or plastic objects) with an actinic radiation curable, substantially all solids composition that provides a matt finish upon curing comprising a means for applying to the object an actinic radiation curable, substantially all solids composition; a means for irradiating the applied coating with a first actinic radiation so as to partially cure the applied coating on the surface; and a means for irradiating the object with a second actinic radiation so as to completely cure the partially cured coating on the surface.

In one embodiment of such assemblages, the actinic radiation curable, substantially all solids composition is comprised of a mixture of at least one oligomer, at least one monomer matt additive, at least one photoinitiator, optionally at least one co-photoinitiator, optionally at least one nano-filler, optionally at least one filler, and optionally at least one polymerizable pigment dispersion. In a further embodiment, the means for irradiating so as to partially cure the coated surface and the means for irradiating so as to completely cure the coated surface are located at an irradiation station so as to not require the transport of the object. In still a further embodiment, the means for applying the composition is located at an application station, wherein the object must be moved from the application station to the irradiation station. In yet a further embodiment, such assemblages further comprise a means for moving the object from the application station to the irradiation station. In still yet a further embodiment, the means for moving comprises a conveyer belt.

In further or alternative embodiments, the irradiation station comprises a means for limiting the exposure of actinic radiation to the application station. In yet further or alternative embodiment, assemblages further comprise a means for rotating the object around at least one axis. In yet further or alternative embodiment, assemblages further comprise a mounting station wherein the object to be coated is attached to a movable unit. In further embodiments, the movable unit is capable of rotating the object around at least one axis. In further or alternative embodiments, the movable unit is capable of moving the object from the application station to the irradiation station.

In still further or alternative embodiments, such assemblages further comprise a removal station wherein the completely cured coated object is removed from the movable unit. In further embodiments, the completely cured coated object does not require cooling prior to removal from the movable unit.

In further or alternative embodiments, the means for applying includes spraying means, brushing means, rolling means, dipping means, blade coating, and curtain coating means. In further embodiments, the means for applying includes a spraying means. In still further embodiments, the spraying means includes equipment for high volume low pressure (HVLP) spraying. In further or alternative embodiments, the means for applying occurs at ambient temperature. In further or alternative embodiments, the spraying means includes equipment for electrostatic spraying. In further or alternative embodiments, the spraying means includes equipment for air-assisted/airless spraying.

In further or alternative embodiments, the application station further comprises a means for reclaiming actinic radiation curable, substantially all solids composition that is non-adhering to the surface of the object. In still further embodiments, the reclaimed actinic radiation curable, substantially all solids composition is subsequently applied to a different object.

In further or alternative embodiments, the first actinic radiation of the assemblage for coating at least a portion of a surface includes actinic radiation selected from the group consisting of visible radiation, near visible radiation, ultra-violet (UV) radiation, and combinations thereof. In further or alternative embodiments, the second actinic radiation of the assemblage for coating at least a portion of a surface includes actinic radiation selected from the group consisting of visible radiation, near visible radiation, ultra-violet (UV) radiation, and combinations thereof. In further or alternative embodiments, the irradiation station includes an arrangement of mirrors.

In another aspect are processes for coating a at least a portion of surface of objects with an actinic radiation curable, substantially all solids composition that provides a matt finish upon curing comprising attaching the object onto a conveying means; applying an actinic radiation curable composition at an application station onto the surface of the object; moving the coated object via the conveying means to an irradiation station; irradiating and partially curing the coated surface at the irradiation station with a first actinic radiation; and irradiating and completely curing the coated surface at the irradiation station with a second actinic radiation.

In further embodiments, such processes further comprise attaching the object to a rotatable spindle prior to the application step. In further or alternative embodiments, such processes further comprise moving the conveying means after attaching the object to the rotatable spindle so as to locate the object near an application station. In further embodiments, such processes further comprise applying an actinic radiation curable composition at the application station as the spindle holding the object rotates. In further embodiments, the conveying means comprises a conveyer belt.

In further or alternative embodiments, the irradiation station comprises a curing chamber containing a first actinic radiation source and a second actinic radiation source.

In further embodiments, such processes further comprise moving the completely cured coated object via the conveying means outside the curing chamber wherein the coated object is packed for storage or shipment.

In further or alternative embodiments, the application station comprises equipment for electrostatic spray. In further or alternative embodiments, the application station comprises equipment suitable for air-assisted/airless spraying. In further or alternative embodiments, the application station comprises equipment suitable for High Volume Low Pressure (HVLP) coatings application. In either case, further or alternative embodiments include processes wherein the coating is applied in a single application, or the coating is applied in multiple applications. Further, in either case, further or alternative embodiments include processes wherein the surface is partially covered by the coating, or the surface is fully covered by the coating.

In further or alternative embodiments, the time between the first actinic radiation step and the second actinic radiation step is less than 5 minutes. In further embodiments, the time between the first actinic radiation step and the second actinic radiation step is less than 1 minute. In further embodiments, the time between the first actinic radiation step and the second actinic radiation step is less than 15 seconds.

In further or alternative embodiments, the length of time of the first actinic radiation step is shorter than the length of time of the second actinic radiation step. In further or alternative embodiments, the length of time of the first actinic radiation step is longer than the length of time of the second actinic radiation step. In further or alternative embodiments, the length of time of the first actinic radiation step is identical to the length of time of the second actinic radiation step.

In further or alternative embodiments, the irradiation station includes at least one light capable of providing actinic radiation selected from the group consisting of visible radiation, near visible radiation, ultra-violet (UV) radiation, and combinations thereof.

In further or alternative embodiments, the irradiation station includes at least one light source capable of providing actinic radiation selected from the group consisting of UV-A radiation, UV-B radiation, UV-B radiation, UV-C radiation, UV-D radiation, or combinations thereof.

In further or alternative embodiments, the irradiation station includes an arrangement of mirrors such that the coated surface is cured in three dimensions. In further or alternative embodiments, the irradiation station includes an arrangement of light sources such that the coated surface is cured in three dimensions. In further embodiments, each light source emits different spectral wavelength ranges. In further embodiments, the different light sources have partially overlapping spectral wavelength ranges.

In another aspect are production lines for coating at least a portion of a surface of objects with an actinic radiation curable, substantially all solids composition that provides a matt finish coating upon curing comprising a process comprising attaching the object onto a conveying means; applying an actinic radiation curable composition at an application station onto the surface of the object; moving the coated object via the conveying means to an irradiation station; irradiating and partially curing the coated surface at the irradiation station with a first actinic radiation; and irradiating and completely curing the coated surface at the irradiation station with a second actinic radiation.

In another aspect are facilities or factories for producing objects coated at least in part with an actinic radiation cured substantially all solids composition that provides a matt finish coating upon curing comprising at least one production line for coating a surface of an object with an actinic radiation curable, substantially all solids composition comprising a process comprising attaching the object onto a conveying means; applying an actinic radiation curable composition at an application station onto the surface of the object; moving the coated object via the conveying means to an irradiation station; irradiating and partially curing the coated surface at the irradiation station with a first actinic radiation; and irradiating and completely curing the coated surface at the irradiation station with a second actinic radiation.

### INCORPORATION BY REFERENCE

All publications, patents and patent applications mentioned in this specification are herein incorporated by reference in their entirety to the same extent as if each individual publication, patent or patent application was specifically and individually indicated to be incorporated by reference.

### DETAILED DESCRIPTION OF THE INVENTION

The monomer matt additives described herein can be used in actinic-radiation curable substantially all solids coating compositions to produce a coating with a matt finish upon curing of the coating composition. The difficulty of producing such a matt finish with an actinic-radiation curable substantially all solids coating compositions is widely recognized. However, the monomer matt additives described herein are widely applicable to virtually any actinic-radiation curable substantially all solids coating composition. Quite simply, the monomer portion of an existing actinic-radiation curable substantially all solids coating composition can be substituted with the monomer matt additives described herein. Thus, by way of example only, if a particular actinic-radiation curable substantially all solids coating composition contains 23% by weight of isobornyl acrylate, a corresponding matt finish can be produced from such a actinic-radiation curable substantially all solids coating compositions by using 23% by weight of an isobornyl acrylate monomer matt additive described herein. To be clear, the monomer matt additives described herein are widely applicable for use in any known actinic-radiation curable substantially all solids coating composition (including those for use on metal substrates, wood substrates, fiber substrates, composite substrates, and plastic substrates).

Thus, for example, the compositions described herein find wide application in the preparation of non-gloss or matt coatings. For example, such compositions can be used in low gloss fluorescent coatings, non-pigmented low gloss coatings, furniture finishes, coatings for airplanes or automobiles, low gloss black coatings for dark rooms, primers for aluminum, surface seals, non-reflecting glass, various laminates, matte finishes for signs, anti-static coatings, water repellent coatings, textured finishes, abrasion indicators, aerosols, playing cards, artificial leathers, high friction surfaces, caulking bases, photoresists, conductivity changing indicators, low gloss adhesives, decorative borders for shiny surfaces, protective layers and the like.

### Glossary of Certain Terms

The term “actinic radiation” as used herein, refers to any radiation source which can produce polymerization reactions, such as, by way of example only, ultraviolet radiation, near ultraviolet radiation, and visible light.

The term “co-photoinitiator,” as used herein, refers to a photoinitiator which may be combined with another photoinitiator or photoinitiators.

The term “corrosion inhibitor”, as used herein, refers to an agent or agents which inhibit, or partially inhibit corrosion.

The term “cure,” as used herein, refers to polymerization, at least in part, of a coating composition.

The term “curable,” as used herein, refers to a coating composition which is able to polymerize at least in part.

The term “curing booster”, as used herein, refers to an agent or agents which boost or otherwise enhance, or partially enhance, the curing process.

The term “filler” refers to a relatively inert substance, added to modify the physical, mechanical, thermal, or electrical properties of a coating.

The term “inorganic pigment”, as used herein, refers to ingredients which are particulate and substantially nonvolatile in use, and includes those ingredients typically labeled as inerts, extenders, fillers or the like in the paint and plastic trade.

The term “irradiating,” as used herein, refers to exposing a surface to actinic radiation.

The term “matt,” also spelled “matte,” as used herein, refers to a non-glossy pigmented coating.

The term “milling” as used herein, refers to the processes of premixing, melting and grinding a powder coating formulation to obtain a powder suitable for spraying.

The term “monomers,” as used herein, refers to substances containing single molecules that can link to oligomers and to each other.

The term “oligomers,” as used herein, refers to molecules containing several repeats of a single molecule.

The term “photoinitiators,” as used herein, refers to compounds that absorb ultra-violet light and use the energy of that light to promote the formation of a dry layer of coating.

The term “polymerizable pigment dispersions,” as used herein, refers to pigments attached to polymerizable resins which are dispersed in a coating composition.

The term “polymerizable resin” or “activated resin,” as used herein, refers to resins which possess reactive functional groups.

The term “pigment,” as used herein, refers to compounds which are insoluble or partially soluble, and are used to impart color.

The term “ultrasonic mixing,” as used herein, refers to any means of mixing/dispersing amorphous silica into a monomer using sonication.

The term “mechanical mixing,” as used herein, refers to any means of mixing/dispersing amorphous silica into a monomer using stirring, shaking, rocking, or mechanical agitation. Examples include use of a sawtooth blade or a helical mixer.

### Monomer Matt Additives

Described herein are monomer matt additives that can be used in actinic radiation curable 100% solids compositions, wherein such compositions upon curing produce a matt finish. The monomer matt additives are formed by dispersing from about 10 wt-% to about 40 wt-% of amorphous silica into a monomer (which makes up the remainder wt-% of the monomer matt additive).

Examples of amorphous silica include colloidal silica, powdered silica, fumed amorphous silica, fused amorphous silica, gelled amorphous silica or precipitated amorphous silica. The average size of the amorphous silica that can be used includes less than about 1 micron, less than about 800 nanometer, less than about 700 nanometer, less than about 600 nanometer, less than about 500 nanometer, less than about 400 nanometer, less than about 300 nanometer, less than about 200 nanometer, or less than about 100 nanometer. In one embodiment, the amorphous silica is approximately spherical in shape. In a further or alternative embodiment, the amorphous silica is a powder. In a further or alternative embodiment, the amorphous silica is colloidal. In a further or alternative embodiment, the amorphous silica is hydrophilic. In a further or alternative embodiment, the amorphous silica does not have surface modification. In a further or alternative embodiment, the amorphous silica is a Nan-O-Sil Colloidal Silica.

Examples of a monomer includes isobornyl acrylate, a tetrahydrofurfuryl acrylate, butanediol acrylate, 2-phenoxyethyl acrylate, a propoxylated glyceral triacrylate, a 1,6-hexanediol diacrylate, a dipropylene glycol diacrylate, a tripropylene glycol diacrylate, a neopentyl glycol propoxylated diacrylate, a trimethylopropane triacrylate, a trimethylopropane ethoxylate triacrylate, a pentaerythritol alkoxylate tetraacrylate, a dimethylopropane tetraacrylate, and combinations thereof.

To prepare the monomer matt additive, the amorphous silica is added to a container along with the monomer (addition of the components can be in any order, or simultaneous). The materials are then subjected to alternating mixing using sonication and mechanical mixing (the two mixing steps are together referred to as a mixing cycle). Notably, the first mixing step can be mechanical mixing or ultrasonic mixing, provided that the next mixing step is the other form of mixing. The components of the composition are mixed until a smooth, homogeneous dispersion is obtained.

In one embodiment, the dispersion is formed by at least one mixing cycle comprising an ultrasonic mixing step and a mechanical mixing step. In a further or alternative embodiment, the at least one mixing cycle is a first ultrasonic mixing step and a second mechanical mixing step. In a further or alternative embodiment, the at least one mixing cycle is a first mechanical mixing step and a second ultrasonic mixing step. In a further or alternative embodiment, the dispersion is formed from at least two mixing cycles, from at least three mixing cycles, from at least four mixing cycles, or from at least five mixing cycles.

In a further or alternative embodiment, each ultrasonic mixing step lasts at least about 1 minute, at least about 2 minutes, at least about 3 minutes, at least about 4 minutes, at least about 5 minutes, at least about 6 minutes, at least about 7 minutes, at least about 8 minutes, at least about 9 minutes, or at least about 10 minutes.

In a further or alternative embodiment, each mechanical mixing step lasts at least about 1 minute, at least about 2 minutes, at least about 3 minutes, at least about 4 minutes, at least about 5 minutes, at least about 6 minutes, at least about 7 minutes, at least about 8 minutes, at least about 9 minutes, or at least about 10 minutes.

In a further or alternative embodiment, each ultrasonic mixing step lasts at least about 1 minute, and each mechanical mixing step lasts at least about 1 minute. In a further or alternative embodiment, each ultrasonic mixing step lasts at least about 2 minutes, and each mechanical mixing step lasts at least about 2 minutes. In a further or alternative embodiment, each ultrasonic mixing step lasts at least about 4 minute, and each mechanical mixing step lasts at least about 4 minute. In a further or alternative embodiment, each ultrasonic mixing step lasts at least about 5 minute, and each mechanical mixing step lasts at least about 5 minute.

In a further or alternative embodiment, each mechanical mixing step lasts less than about 30 minutes, less than about 25 minutes, less than about 20 minutes, less than about 15 minutes, or less than about 10 minutes.

In a further or alternative embodiment, each ultrasonic mixing step lasts less than about 30 minutes, less than about 25 minutes, less than about 20 minutes, less than about 15 minutes, or less than about 10 minutes.

100% Solids, UV-Curable Coating that Produce a Matt Finish Upon Curing

Described herein are sprayable, 100% solids compositions, methods of using the compositions for coating surfaces, and the processes of coating surfaces. Importantly, such compositions, upon curing, produce a matt finish. The 100% solids coating compositions described herein all comprise a monomer matt additive. In addition, such compositions include actinic radiation curable materials (by way of example, monomers and oligomers), photoinitiators, solid pigment dispersions, adhesion promoters, nano-fillers, and fillers for the coating of surfaces of flexible objects (by way of example only, metal or plastic objects), or objects comprising angular features, and which may be sprayed by conventional methods, including, but not limited to, HVLP, air-assisted/airless, or electrostatic bell in one coat, with no additional heat applied. In addition, the 100% solids coating compositions described herein impart a matt finish that can have flexibility, corrosion resistance, abrasion resistance, and improved adhesion.

The 100% solids UV-curable coating compositions described herein do not use added solvent. This is achieved, in part, by the use of low molecular weight monomers which take the place of organic solvents. However, these monomers are not as volatile as organic solvents, and therefore do not evaporate as readily as volatile organic solvents. Also, in contrast to volatile organic solvent, such monomers become an integral component of the final coating and contribute to the final coating properties and characteristics. The lack of volatile organic solvents in such UV-curable coating compositions limits health, safety, and environmental risks posed by such solvents.

The 100% solids, UV-curable coating compositions described herein can be used to coat numerous objects, such as, by way of example only, metal, wood, composite, fiber or plastic objects.

The 100% solids, UV-curable coating compositions described herein can be applied to surfaces by spraying, curtain coating, dipping, rolling or brushing. However, spraying is the one of the most efficient methods of application, and this can be accomplished using High Volume Low Pressure (HVLP) methodology or electrostatic spraying technology. HVLP and electrostatic spraying techniques are methods well established in the coating industry, thus it is adventitious to develop coating compositions which utilize these application means. In addition, the UV-curable compositions described herein may be applied using air-assisted/airless type spraying technology. Air-assisted airless pumps are usually air-operated, positive displacement, reciprocating piston pumps that siphon coating compositions directly out of a container. An air compressor operates both the pump and the gun at about one-quarter the amount of air needed for a conversion HVLP gun, with the fluid is delivered at a significantly higher fluid pressure. The coating composition atomizes as it escapes to atmospheric pressure, and the gun then adds a little bit of air to the ends of the spray pattern, eliminating the “tails” or heavy edges, thereby minimizing overlapping lines or stripes. Thus, the “air assist” of the “airless” process.

The methods and compositions described herein require limited and simple (if any) cleaning prior to coating an object. In one embodiment, cleaning an article prior to coating with the 100% solids, UV-curable coating compositions described herein simply requires washing with a biodegradable organic cleaner and water to remove loose impurities, surface soils, oil and grease, a water rinse, and drying. The water rinse can use deionized, purified water or tap water, with a contact time and/or water flow rate sufficient to remove substantially all of the cleaner from the surface. The waste stream from this simplified cleaning process contains less toxic and/or harmful materials than the process used for solvent-based coating compositions. Thus, this cleaning process is more environmentally friendly than the process used for solvent-based coating compositions.

The characteristics of the UV curable, 100% solids compositions described herein include, but are not limited to, zero VOC's, zero HAP's, cure in seconds, for example, but not limited to, 1.5 seconds, (thereby decreasing cure time by 99%), require up to 80% less floor space, require up to 80% less energy, are non-flammable, require no thinning, are extremely durable, have a matt finish upon curing, applied using HVLP or electrostatic bell, do not require flash off ovens, do not require thermal cure, have no thermal stress and no orange peel effect. Further, they enable the user to decrease production time while producing a product with superior, more reproducible appearance. The user stands to save time, energy, and space. In addition, the user may reduce or eliminate emissions as no solvent or vehicles are used.

Processes and assemblages for applying sprayable, ultraviolet light curable, 100% solids compositions described herein are disclosed. Characteristics of the processes include, but are not limited to, providing an industrial strength coating, having up to 98% reclamation of overspray, no cooling line required, immediate “pack and ship,” decreased parts in process, less workholders, no workholder burn off, eliminate air pollution control systems, safer for the environment, safer for employees, decreased production costs, decreased production time, and increased production.

Compositions of 100% Solids, UV-Curable Coating that Produce a Matt Finish Upon Curing

The key component of the UV-curable coatings described herein is that they contain a monomer matt additive. Provided that sufficient monomer matt additive is included in the formulation, the coating, upon curing, has a matt finish. Generally, any actinic-radiation curable substantially all solids coating compositions can be converted into a composition that provides a matt finish upon curing by simply substituting the monomer in the base composition with a monomer matt additive. The substitution can be an exact wt-% substitution, but that is not necessary.

As examples Only:

In one example the actinic radiation curable, substantially all solids compositions described herein are comprised of a mixture of at least one oligomer, at least one monomer matt additive, at least one photoinitiator, and at least one nano-filler, wherein the composition can provide a matt finish, upon curing, on a metal or plastic object. In a further embodiment, the cured composition can provide a flexible, corrosion resistant, abrasion resistant and scratch resistant coating on a metal or plastic object.

In an embodiment of the aforementioned aspect, the actinic radiation curable, substantially all solids composition comprises at least one oligomer or a multiplicity of oligomers present in the mixture between about 15-45% by weight. In a further or alternative embodiment of the above aspect, the actinic radiation curable, substantially all solids composition comprises at least one monomer matt additive present in the mixture between about 25-65% by weight. In further or alternative embodiments, the actinic radiation curable, substantially all solids composition comprises at least one photoinitiator or a multiplicity of photoinitiators present in the mixture between about 2-10% by weight. In a still further or alternate embodiment, the actinic radiation curable, substantially all solids composition comprises at least one nano-filler or a multiplicity of nano-fillers present in the mixture between about 0.1-25% by weight. In further or alternative embodiments of the aforementioned aspect, the actinic radiation curable, substantially all solids composition optionally comprises up to about 5% by weight of a filler or a multiplicity of fillers. In further or alternative embodiments of the aforementioned aspect, the actinic radiation curable, substantially all solids composition optionally comprises up to about 10% by weight of a polymerizable pigment dispersion or a multiplicity of polymerizable pigment dispersions. In still further or alternative embodiments of the aforementioned aspect, the actinic radiation curable, substantially all solids composition mixture comprises 15-45% percent by weight of an oligomer or a multiplicity of oligomers, and 25-65% by weight of a monomer matt additive. In further or alternative embodiments of this aspect, the actinic radiation curable, substantially all solids composition comprises 15-45% percent by weight of an oligomer or a multiplicity of oligomers, 25-65% by weight a monomer matt additive and 2-10% by weight of a photoinitiator or a multiplicity of photoinitiators. In still further or alternative embodiments, the actinic radiation curable, substantially all solids composition comprises 15-45% percent by weight of an oligomer or a multiplicity of oligomers, 25-65% by weight of a monomer matt additive, 2-10% by weight of a photoinitiator or a multiplicity of photoinitiators, and 0.1-25% by weight of a nano-filler or a multiplicity of nano-fillers. In further or alternative embodiments, the actinic radiation curable, substantially all solids comprises 15-45% percent by weight an oligomer or a multiplicity of oligomers, 25-65% by weight of a monomer matt additive, 2-10% by weight of a photoinitiator or a multiplicity of photoinitiators, 0.1-25% by weight of a nano-filler or a multiplicity of nano-fillers, and up to about 5% by weight of a filler or a multiplicity of fillers. In even further or alternative embodiments, the actinic radiation curable, substantially all solids composition comprises 15-45% percent by weight an oligomer or a multiplicity of oligomers, 30-65% by weight of a monomer matt additive, 2-10% by weight of a photoinitiator or a multiplicity of photoinitiators, 0.1-5% by weight of a nano-filler or a multiplicity of nano-fillers, up to about 5% by weight of a filler or a multiplicity of fillers, and up to about 10% by weight of a polymerizable pigment dispersion or a multiplicity of polymerizable pigment dispersions.

In another example are environmentally friendly actinic radiation curable, substantially all solids compositions that provide a matt finish coating for thermally sensitive objects which may or may not be rusty. In one embodiment the actinic radiation curable, substantially all solids compositions are comprised of a mixture of oligomers, a monomer matt additive, photoinitiators, co-photoinitiators, fillers, and polymerizable pigment dispersions. In one embodiment of the this aspect, the actinic radiation curable, substantially all solids composition mixture may comprise 25-45% by weight of an oligomer or a multiplicity of oligomers, a monomer matt additive, photoinitiators, co-photoinitiators, fillers, and polymerizable pigment dispersions.

In another embodiment of the above aspect, the actinic radiation curable, substantially all solids composition mixture comprises 45-60% by weight of a monomer matt additive; plus oligomers, photoinitatiors, co-photoinitiators, fillers, and polymerizable pigment dispersions. In a further embodiment of the aforementioned aspect, the actinic radiation curable, substantially all solids composition mixture comprises 2-11% by weight of a photoinitiator or a multiplicity of photoinitiators and co-initiators; plus oligomers, a monomer matt additive, fillers, and polymerizable pigment dispersions. In a still further embodiment of the above aspect, the actinic radiation curable, substantially all solids composition mixture comprises 0.1-3% by weight of a filler or a multiplicity of fillers; plus oligomers, a monomer matt additive, photoinitatiors, co-photoinitiators, and polymerizable pigment dispersions. In yet another embodiment of the aforementioned aspect, the actinic radiation curable, substantially all solids composition mixture comprises 8-12% by weight of a polymerizable pigment dispersion or a multiplicity of polymerizable pigment dispersions; plus oligomers, a, photo monomer matt additive initatiors, co-photoinitiators, and fillers. In an embodiment of the above aspect, the actinic radiation curable, substantially all solids composition comprises 25-45% percent by weight of an oligomer or a multiplicity of oligomers, and 45-60% by weight of a monomer matt additive; plus photoinitatiors, co-photoinitiators, fillers, and polymerizable pigment dispersions. In another embodiment of the aforementioned aspect, the actinic radiation curable, substantially all solids composition comprises 25-45% percent by weight of an oligomer or a multiplicity of oligomers, 45-60% by weight a monomer matt additive and 2-11% by weight of a photoinitiator or a multiplicity of photoinitiators and co-initiators; plus, fillers, and polymerizable pigment dispersions. In a further embodiment of the above aspect, the actinic radiation curable, substantially all solids composition mixture comprises 25-45% percent by weight of an oligomer or a multiplicity of oligomers, 45-60% by weight of a monomer matt additive, 2-11% by weight of a photoinitiator or a multiplicity of photoinitiators and co-initiators and 0.1-3% by weight of a filler or a multiplicity of fillers; plus polymerizable pigment dispersions. In still further embodiment of the aforementioned aspect, the actinic radiation curable, substantially all solids composition mixture comprises 25-45% percent by weight an oligomer or a multiplicity of oligomers, 45-60% by weight of a monomer matt additive, 2-11% by weight of a photoinitiator or a multiplicity of photoinitiators and co-initiators, 0.1-3% by weight of a filler or a multiplicity of fillers, and 8-12% by weight of a polymerizable pigment dispersion or a multiplicity of polymerizable pigment dispersions.

In another example, the actinic radiation curable, substantially all solids compositions described herein are comprised of a mixture of at least one oligomer, at least one monomer matt additive, at least one photoinitiator, at least one surfactant, at least one nano-filler, optionally at least one filler, and optionally at least one polymerizable pigment dispersion, wherein the composition when cured as a coating on a composite material provides a matt finish coating.

In an embodiment of the aforementioned aspect, the actinic radiation curable, substantially all solids composition comprises at least one oligomer or a multiplicity of oligomers present in the mixture between about 15-40% by weight. In a further or alternative embodiment of the above aspect, the actinic radiation curable, substantially all solids composition comprises at least one monomer matt additive present in the mixture between about 50-60% by weight. In further or alternative embodiments, the actinic radiation curable, substantially all solids composition comprises at least one photoinitiator or a multiplicity of photoinitiators present in the mixture between about 1-10% by weight. In a still further or alternate embodiment, the actinic radiation curable, substantially all solids composition comprises at least one nano-filler or a multiplicity of nano-fillers present in the mixture between about 5-30% by weight. In further or alternative embodiments of the aforementioned aspect, the actinic radiation curable, substantially all solids composition comprises at least one surfactant or a multiplicity of surfactants between about 0.01-2% by weight. In further or alternative embodiments of the aforementioned aspect, the actinic radiation curable, substantially all solids composition optionally comprises up to about 5% by weight of a UV absorber or a multiplicity of UV absorbers. In further or alternative embodiments of the aforementioned aspect, the actinic radiation curable, substantially all solids composition optionally comprises up to about 10% by weight of a polymerizable pigment dispersion or a multiplicity of polymerizable pigment dispersions. In still further or alternative embodiments of the aforementioned aspect, the actinic radiation curable, substantially all solids composition mixture comprises 15-40% percent by weight of an oligomer or a multiplicity of oligomers, and 50-60% by weight of a monomer matt additive. In further or alternative embodiments of this aspect, the actinic radiation curable, substantially all solids composition comprises 15-40% percent by weight of an oligomer or a multiplicity of oligomers, 50-60% by weight a monomer matt additive and 1-10% by weight of a photoinitiator or a multiplicity of photoinitiators. In still further or alternative embodiments, the actinic radiation curable, substantially all solids composition comprises 15-40% percent by weight of an oligomer or a multiplicity of oligomers, 50-60% by weight of a monomer matt additive, 1-10% by weight of a photoinitiator or a multiplicity of photoinitiators, and 5-30% by weight of a nano-filler or a multiplicity of nano-fillers. In further or alternative embodiments, the actinic radiation curable, substantially all solids comprises 15-40% percent by weight an oligomer or a multiplicity of oligomers, 50-60% by weight of a monomer matt additive, 1-10% by weight of a photoinitiator or a multiplicity of photoinitiators, 5-30% by weight of a nano-filler or a multiplicity of nano-fillers, and 0.01-2% by weight of a surfactant or a multiplicity of surfactants. In even further or alternative embodiments, the actinic radiation curable, substantially all solids composition comprises 15-40% percent by weight an oligomer or a multiplicity of oligomers, 50-60% by weight of a monomer matt additive, 1-10% by weight of a photoinitiator or a multiplicity of photoinitiators, 5-30% by weight of a nano-filler or a multiplicity of nano-fillers, 0.01-2% by weight of a surfactant or a multiplicity of surfactants, and up to about 5% by weight of a UV absorber or a multiplicity of UV absorbers. In even further or alternative embodiments, the actinic radiation curable, substantially all solids composition comprises 15-40% percent by weight an oligomer or a multiplicity of oligomers, 50-60% by weight of a monomer matt additive, 1-10% by weight of a photoinitiator or a multiplicity of photoinitiators, 5-30% by weight of a nano-filler or a multiplicity of nano-fillers, 0.01-2% by weight of a surfactant or a multiplicity of surfactants, up to about 5% by weight of a UV absorber or a multiplicity of UV absorbers and up to about 10% by weight of a polymerizable pigment dispersion or a multiplicity of polymerizable pigment dispersions.

In any of the aforementioned compositions, in one embodiment, the room temperature viscosity of the composition is up to about 500 centipoise, up to about 450 centipoise, up to about 400 centipoise, up to about 350 centipoise, up to about 300 centipoise, up to about 250 centipoise, up to about 200 centipoise, up to about 150 centipoise, up to about 100 centipoise.

The oligomers may be selected from the group consisting of monoacrylates, diacrylates, triacrylates, polyacrylates, urethane acrylates, polyester acrylates, polyether acrylates, epoxy acrylates and mixtures thereof. Suitable compounds which may be used include, but are not limited to, trimethylolpropane triacrylate, alkoxylated trimethylolpropane triacrylate, such as ethoxylated or propoxylated trimethyolpropane triacrylate, 1,6-hexane diol diacrylate, isobornyl acrylate, aliphatic urethane acrylates (di-, tri-, hex-: Ebecryl 230, Ebecryl 244, Ebecryl 264, Ebecryl 220), vinyl acrylates, epoxy acrylates, ethoxylated bisphenol A diacrylates, trifunctional acrylic ester, unsaturated cyclic diones, polyester diacrylates; epoxy diacrylate/monomer blends, aliphatic urethane triacrylate/monomer blends, aliphatic urethane triacrylates blended with 1,6-hexanediol acrylate, hexafunctional urethane acrylates, siliconized urethane acrylates, aliphatic siliconized urethane acrylates, CN990 (Sartomer, Exton, Pa., U.S.A.), bisphenol epoxy acrylates blended with trimethylolpropane triacrylate, fatty acid modified bisphenol A acrylates, acrylated epoxy polyol blended with trimethylolpropane triacrylate, and mixtures thereof.

The monomers are chosen from a group consisting of 2-phenoxyethyl acrylate, isobornyl acrylate, acrylate ester derivatives, methacrylate ester derivatives; trimethylolpropane triacrylate, 2-phenoxyethyl acrylate esters, and cross-linking agents, such as, but not limited to, propoxylated glyceryl triacrylate, tripropylene glycol diacrylate, and mixtures thereof.

The rapid polymerization reaction is initiated by a photoinitiator component of the composition when exposed to ultraviolet light. The photoinitiators used in the compositions described herein are categorized as free radicals; however, other photoinitiator types can be used. Furthermore, combinations of photoinitiators may be used which encompass different spectral properties of the UV sources used to initiate polymerization. In one embodiment, the photoinitiators are matched to the spectral properties of the UV sources. It is to be appreciated that the compositions described herein may be cured by medium pressure mercury arc lights which produce intense UV-C (200-280 nm) radiation, or by doped mercury discharge lamps which produce UV-A (315-400 nm) radiation, or UV-B (280-315 nm) radiation depending on the dopant, or by combination of lamp types depending on the photoinitiator combinations used. In addition, the presence of pigments can absorb radiation both in the UV and visible light regions, thereby reducing the effectiveness of some types of photoinitator. However, phosphine oxide type photoinitiators, for example but not limited to bis acylphosphine oxide, are effective in pigmented, including, by way of example only, black, UV-curable coating materials. Phosphine oxides also find use as photoinitiators for white coatings.

The photoinitiators and co-photoinitiators may be selected from a group consisting of phosphine oxide type photoinitiators, diphenyl (2,4,6-trimethylbenzoyl) phosphine oxide, benzophenone, 1-hydroxycyclohexyl phenyl ketone, 2-hydroxy-2-methyl-1-phenyl-propan-1-one (DAROCUR® 1173 from Ciba Specialty Chemicals 540 White Plains Road, Tarrytown, N.Y., U.S.A.)), 2,4,6-trimethylbenzophenone and 4-methylbenzophenone, ESACURE® KTO-46 (Lamberti S.p.A., Gallarate (VA), Italy), oligo(2-hydroxy-2-methyl-1-(4-(1-methylvinyl)phenyl)propanone), amine acrylates, thioxanthones, benzyl methyl ketal, and mixtures thereof. In addition, the photoinitiators and co-photoinitiators may be selected from 2-hydroxy-2-methyl-1-phenyl-propan-1-one (DAROCUR® 1173 from Ciba Specialty Chemicals 540 White Plains Road, Tarrytown, N.Y., U.S.A.), phosphine oxide type photoinitiators, IRGACURE® 500 (Ciba Specialty Chemicals 540 White Plains Road, Tarrytown, N.Y., U.S.A.), amine acrylates, thioxanthones, benzyl methyl ketal, and mixtures thereof. In addition, thioxanthone is used as a curing booster. The liquid photoinitiator is chosen from a group consisting of benzonephenones, 1-hydroxycyclohexyl phenyl ketone, phosphine oxides, and mixtures thereof. The solid photoinitiator is a phosphine oxide.

Other photoinitiators which are suitable for use in the practice described herein include, but are not limited to, 1-phenyl-2-hydroxy-2-methyl-1-propanone, oligo {2-hydroxy-2 methyl-1-4-(methylvinyl)phenylpropanone)}, 2-hydroxy 2-methyl-1-phenyl propan-1 one, bis (2,6-dimethoxybenzoyl)-2,4,4-trimethylpentyl phosphine oxide, 1-hydroxycyclohexyl phenyl ketone and benzophenone as well as mixtures thereof. Still other useful photoinitiators include, for example, bis(n,5,2,4-cyclopentadien-1-yl)-bis 2,6-difluoro-3-(1H-pyrol-1-yl) phenyl titanium and 2-benzyl-2-N,N-dimethyl amino-1-(4-morpholinophenyl)-1-butanone. These compounds are IRGACURE® 784 and IRGACURE® 369, respectively (both from Ciba Specialty Chemicals 540 White Plains Road, Tarrytown, N.Y., U.S.A.) While, still other useful photoiniators include, for example, 2-methyl-1-4(methylthio)-2-morpholinopropan-1-one, 4-(2-hydroxy) phenyl-2-hydroxy-2-(methylpropyl)ketone, 1-hydroxy cyclohexyl phenyl ketone benzophenone, (cyclopentadienyl)(1-methylethyl)benzene-iron hexafluorophosphate, 2,2-dimethoxy-2-phenyl-1-acetophen-one 2,4,6-trimethyl benzoyl-diphenyl phosphine oxide, benzoic acid, 4-(dimethyl amino)-ethyl ether, as well as mixtures thereof.

Corrosion inhibitors are formulated into coatings to minimize corrosion of the substrate to which it is applied. Suitable corrosion inhibitors can be selected from organic pigments, inorganic pigments, organometallic pigments or other organic compounds which are insoluble in the aqueous phase. It is also possible to use concomitantly anti-corrosion pigments, for example pigments containing phosphates or borates, metal pigments and metal oxide pigments, for example but not limited to zinc phosphates, zinc borates, silicic acid or silicates, for example calcium or strontium silicates, and also organic pigments corrosion inhibitor based on aminoanthraquinone. In addition inorganic corrosion inhibitors, for example salts of nitroisophthalic acid, tannin, phosphoric esters, substituted benzotriazoles or substituted phenols, can be used. Furthermore, sparingly water-soluble titanium or zirconium complexes of carboxylic acids and resin bound ketocarboxylic acids are particularly suitable as corrosion inhibitors in coating compositions for protecting metallic surfaces. In addition, an embodiment is an all-solids, non-metal corrosion inhibitor, including by way of example only, Cortec Corporation's (4119 White Bear Parkway, St. Paul, Minn., U.S.A.), M-235 product, and any other upgrades and superseding products.

Pigments, are insoluble white, black, or colored material, typically suspended in a vehicle for use in a paint or ink, and may also include effect pigments such as micas, metallic pigments such as aluminum, and opalescent pigments.

An “ideal” dispersion consists of a homogeneous suspension of primary particles. However, inorganic pigments are often incompatible with the resin in which they are incorporated, and this generally results in the failure of the pigment to uniformly disperse. Furthermore, a milling step may be required as dry pigments comprise a mixture of primary particles, aggregates, and agglomerates which must be wetted and de-aggregated before the production of a stable, pigment dispersion is obtained. The level of dispersion in a particular pigment-containing coating composition affects the application properties of the composition as well as the optical properties of the cured film. Improvements in dispersion result in improvements in strength and matt retention.

Treatment of the pigment surface to incorporate reactive functionality improves pigment dispersion. Examples of surface modifiers include, but are not limited to, polymers such as polystyrene, polypropylene, polyesters, styrene-methacrylic acid type copolymers, styrene-acrylic acid type copolymers, polytetrafluoroethylene, polychlorotrifluoroethylene, polyethylenetetrafluoroethylene type copolymers, polyaspartic acid, polyglutamic acid, and polyglutamic acid-γ-methyl esters, and modifiers such as silane coupling agents and alcohols.

These surface-modified pigments improve the pigment dispersion in a variety of resins, for example, olefins such as, by way of example only, polyethylene, polypropylene, polybutadiene, and the like; vinyls such as polyvinylchloride, polyvinylesters, polystyrene; acrylic homopolymers and copolymers; phenolics; amino resins; alkyds, epoxys, siloxanes, nylons, polyurethanes, phenoxys, polycarbonates, polysulfones, polyesters (optionally chlorinated), polyethers, acetals, polyimides, and polyoxyethylenes.

Various organic pigments can be used in the compositions described herein, including, but not limited to, carbon black, azo-pigment, phthalocyanine pigment, thioindigo pigment, anthraquinone pigment, flavanthrone pigment, indanthrene pigment, anthrapyridine pigment, pyranthrone pigment, perylene pigment, perynone pigment and quinacridone pigment.

Various inorganic pigments can be used in the compositions described herein, for example, but not limited to, titanium dioxide, aluminum oxide, zinc oxide, zirconium oxide, iron oxides: red oxide, yellow oxide and black oxide, Ultramarine blue, Prussian blue, chromium oxide and chromium hydroxide, barium sulfate, tin oxide, calcium, titanium dioxide (rutile and anatase titanium), sulfate, talc, mica, silicas, dolomite, zinc sulfide, antimony oxide, zirconium dioxide, silicon dioxide, cadmium sulfide, cadmium selenide, lead chromate, zinc chromate, nickel titanate, clays such as kaolin clay, muscovite and sericite.

The solid pigment dispersions used in the compositions described herein may also be selected from a group consisting of the following pigments bonded with modified acrylic resins: carbon black, rutile titanium dioxide, organic red pigment, phthalo blue pigment, red oxide pigment, isoindoline yellow pigment, phthalo green pigment, quinacridone violet, carbazole violet, masstone black, light lemon yellow oxide, light organic yellow, transparent yellow oxide, diarylide orange, quinacridone red, organic scarlet, light organic red, and deep organic red. These polymerizable pigment dispersions are distinguishable from other pigment dispersions which disperse insoluble pigment particles in some type of resin and entrap the pigment particles within a polymerized matrix. The pigment dispersions used in the compositions and methods described herein have pigments treated such that they are attached to acrylic resins; consequently the pigment dispersion is polymerizable upon exposure to UV irradiation and becomes intricately involved in the overall coating properties.

The average particle size of fillers in the compositions described herein includes by way of example less than about 20 μm, and by way of further example, with an average particle size 1 to 10 μm discrete particles; whereas, the average particle size of nano-filler particles includes by way of example less than about 200 nm, and by way of further example, with an average particle size 5 to 50 nm discrete particles. to nanometer-sized particles. The addition of fillers imparts certain rheological properties to the composition, such as viscosity; however, the addition of nanoscale fillers imparts dramatically different effects on the coating mechanical properties in comparison to micron scale fillers. Thus, the mechanical properties of coatings can be manipulated by varying the content of micron sized fillers and nano-fillers in the coating composition.

Polymer nanocomposites are the blend of nanometer-sized fillers with either a thermoset or UV-curable polymers, and such polymer nanocomposites have improved properties compared to conventional filler materials. These improved properties include improved tensile strength, modulus, heat distortion temperature, barrier properties, UV resistance, abrasion and scratch resistance, and conductivity. The incorporation of certain nano-fillers, such as nano-alumina and nano-silicon, can provide long-term abrasion resistant coatings without significantly effecting optical or physical properties. These improved properties may be in large part due to the small size and large surface area of the nanoscale fillers.

Fillers and nano-fillers can be either insoluble inorganic particles, or insoluble organic particles. The inorganic fillers and nano-fillers are generally metal oxides, although other inorganic compounds can be used. Examples of inorganic fillers and nano-fillers include aluminum nitrides, aluminum oxides, antimony oxides, barium sulfates, bismuth oxides, cadmium selenides, cadmium sulfides, calcium sulfates, cerium oxides, chromium oxides, copper oxides, indium tin oxides, iron oxides, lead chromates, nickel titanates, niobium oxides, rare earth oxides, silicas, silicon dioxides, silver oxides, tin oxides, titanium dioxides, zinc chromates, zinc oxides, zinc sulfides, zirconium dioxides, and zirconium oxides. Alternatively, organic fillers and nano-fillers are generally polymeric materials ground into appropriate sized particulates. Examples of nanometer sized organic nano-fillers include, but are not limited to, nano-polytetrafluoroethylene, acrylate nanosphere colloids, methacrylate nanosphere colloids, and combinations thereof, although micron sized fillers of the polytetrafluoroethylene, acrylate, methacrylate, and combinations thereof may be used.

Nano-alumina is composed of high purity aluminum oxide that is of nanometer size, including by way of example less than 200 nm, and within the range of approximately 5-40 nanometer discrete spherical particles. The incorporation of nano-alumina into coating systems maintains excellent physical properties of the coatings. In addition, incorporation of nano-alumina into coating compositions can results in extremely hard coatings, which may replace “hard chrome”, and find use in coating objects which may need impact resistance.

“Hard chrome” is generally obtained from the process of electrodepositing a thick layer (0.2 mils to 30 mils or more) of chromium, usually applied directly to ferrous substrates, like steel, although it can also be applied to non-ferrous substrates. The thick chrome is almost always deposited from a hexavalent chromium plating bath. “Hard chrome” can be used for the hard tipping of cutting tools and to build up shafts or areas on steel that are subject to severe wear. The chromium deposit is usually selected to take advantage of its desirable properties, such as hardness, wearability, corrosion resistance, lubricity, and low coefficient of friction. A variety of parts which can be hard chrome plated include, hydraulic rods and cylinders, aircraft jet engine components, diesel cylinder liners, pneumatic struts for automobile hatchbacks, shock absorbers, aircraft landing gear, railroad wheel bearings and couplers, tool and die parts, and molds for the plastic and rubber industry.

Chromium can exist in two valence states, trivalent chromium (Cr III) and hexavalent chromium (Cr VI). Chromium III is an essential element in humans and is much less toxic than chromium (VI). The respiratory tract is the major target organ for chromium (VI) toxicity, for acute (short-term) and chronic (long-term) inhalation exposures. Shortness of breath, coughing, and wheezing can occur from acute exposure to chromium (VI), while perforations and ulcerations of the septum, bronchitis, decreased pulmonary function, pneumonia, and other respiratory effects have been noted from chronic exposure. Human studies have clearly established that inhaled chromium (VI) is a human carcinogen, resulting in an increased risk of lung cancer. It is clear that hexavalent chromium plating baths have significant health risks and environmental toxicity issues associated with their use to obtain hard coatings. In addition, the use of the hard chrome plating process can take several hours to build up, and is therefore very time consuming. Thus, there is a need for the development of coatings which are easy and rapid to apply, are not a health risk, and are also not hazardous to the environment. Coating compositions which incorporate nano-alumina are environmentally friendly, can be applied easily and quickly, and result in hard, highly abrasion resistant and scratch resistant coatings.

Nano-silicon dioxides having a nanometer size, including by way of example less than about 200 nm, and by way of further example, with an average particle size 5 to 40 nm, can be incorporated into coating compositions with up to 40-65% silica content with little increase in composition viscosity. Other properties and features obtained when incorporating nano-silicon into coating compositions are, it acts as a barrier effect against gases, water vapor and solvents, it has increased weathering resistance and inhibited thermal aging, it exhibits reduced cure shrinkage and heat of reaction, reduced thermal expansion and internal stresses, increased tear resistance, fracture toughness and modulus, has improved adhesion to a large number of inorganic substrates (e.g. glass, aluminium), has improved dirt resistance against inorganic impurities (e.g. soot) by a more hydrophilic surface, and has improvements to other desired properties such as: thermal stability, stain-resistance, heat conductivity, dielectric properties.

Other materials having properties such as wear resistance, hardness, stiffness, abrasion resistance, chemical resistance, and corrosion resistance which may be used as nano-fillers include: oxides, carbides, nitrides, borides, silicates, ferrites and titanates. For instance, examples of such nano-fillers are, but not limited to, nano-zirconium oxide, nano-zirconium dioxides, nano-silicon carbide, nano-silicon nitride, nano-sialon (silicon aluminum oxynitride), nano-aluminum nitrides, nano-bismuth oxides, nano-cerium oxides, nano-copper oxides, nano-iron oxides, nano-nickel titanates, nano-niobium oxides, nano-rare earth oxides, nano-silver oxides, nano-tin oxides, and nano-titanium oxides. In addition to these properties, these materials have relatively high mechanical strength at high temperatures.

Alternatively, the micron sized fillers used in the composition described herein are selected from a group consisting of amorphous silicon dioxide prepared with polyethylene wax, synthetic amorphous silica with organic surface treatment, untreated amorphous silicon dioxide, alkyl quaternary bentonite, colloidal silica, acrylated colloidal silica, alumina, zirconia, zinc oxide, niobia, titania aluminum nitride, silver oxide, cerium oxides, and combinations thereof. The silicon dioxides are chosen from a group consisting of both synthetic and natural silicon dioxides with surface treatments including polyethylene wax or waxes and IRGANOX® from Ciba Specialty Chemicals 540 White Plains Road, Tarrytown, N.Y., U.S.A.

UV absorbers may be incorporated into the coating compositions described herein to further add to the UV resistance properties already imparted by the use of nano-fillers in the coating compositions described herein. The UV absorbers which may be incorporated into composition described herein include, but are not limited to, hindered amine light stabilizers and the Tinuvin® products from Ciba® Specialty Chemicals, Basel, Switzerland, such as 2-hydroxyphenyltriazine (Tinuvin® 400). Note that Tinuvin® 400 is flammable and should be used with the necessary safety precautions.

The surfactants incorporated into composition described herein include, but are not limited to, Tego Rad 2100 (Tego Division of Degussa Corporation), Tego Rad 2500 (Tego Division of Degussa Corporation), Dabco DC 5103 (Air Products), and combinations thereof.

Slip indicates the ease with which two contacting surfaces can move by each other. Coatings are said to have good slip when they have a low coefficient of friction and poor slip when they have a high coefficient of friction. Coated surfaces which are tack-free and behave as if they are lubricated have good slip characteristics, allowing coated materials to slide by one another. Slip is an important characteristic of coated objects, particularly objects which benefit from minimal friction such as, but not limited to, hydraulic rods, hydraulic cylinders, wheel bearings and shock absorbers. In addition, manufacturing processes such as, but not limited to, forming operations, filling, handling and shipping, may also benefit from the use of coated objects with good slip properties. To provide good substrate wetting and slip with no migration properties to the coated surface it is desirable to incorporate some type of slip and flow enhancer, also referred herein as a slip and flow improver, into the composition. Slip and flow enhancers reduce the friction coefficient and surface tension, thereby facilitating spreading of coating compositions and improving slip characteristics of cured coatings. Slip and flow enhancers may be waxes, polymeric compounds, monomers, inorganic compounds, or organic compounds. Examples of slip and flow enhancers are, but not limited to, various waxes, silicones, modified polyesters, acrylated silicone, molybdenum disulfide, tungsten disulfide, EBECRYL® 350 (UCB Surface Specialties, Brussels, Belgium), EBECRYL® 1360 (UCB Surface Specialties, Brussels, Belgium), and CN990 (Sartomer, Exton, Pa., U.S.A.), polytetrafluoroethylene, a combination of polyethylene wax and polytetrafluoroethylene, dispersion of low molecular weight polyethylene or polymeric wax, silicone oils, and the like. Slip and flow enhancers typically comprise less than 20% by weight of a coating composition. When slip and flow enhancers are incorporated as minor components into coating compositions, they are referred to as additives, and typically, by way of example only, comprise less than 5% by weight of a coating composition. Alternatively, slip and flow enhancers may be a significant proportion of the formulation, and may be referred to as slip and flow enhancing oligomers as they are an integral component of the resulting coating. Typically, by way of example only, slip and flow enhancing oligomers comprise greater than 10%, of a coating composition. An example of such a slip and flow enhancing oligomer is CN990 (Sartomer, Exton, Pa., U.S.A.). The compositions described herein may incorporate slip and flow enhancers, as additives or slip and flow enhancing monomers, and optionally nano-fillers to obtain cured coatings with enhanced slip properties.

### 100% Solids, UV-Curable Coating Composition Use

Possible methods of applying the composition described herein include spraying, brushing, curtain coating, dipping, and rolling. To enable spraying onto a desired surface the pre-polymerization viscosity must be controlled. This is achieved by the use of low molecular weight monomers which take the place of organic solvents. However, these monomers also participate and contribute to final coating properties and do not evaporate. The viscosity of the composition described herein is from about 2 centipoise to about 500 centipoise; wherein a viscosity of approximately 500 centipoise or less at room temperature allows for coverage in one coat with application by HVLP, air-assisted/airless, or electrostatic bell without the addition of heat.

By the combination of a properly formulated 100% solids UV-curable coating and the appropriate frequencies of light, UV radiation is able to penetrate opaque coatings to reach the base substrate, thereby fully curing the coating. Since this curing process is almost instantaneous, requiring (for example) an average of 1.5 seconds per light, both time and energy are conserved. Curing lights used may be high pressure mercury lamps, mercury lamps doped with gallium or iron, or in combination as required. Lamps may be powered by direct application of voltage, by microwaves, or by radio-waves.

A coating composition is prepared using a mixture of photoinitiators sufficient to encompass all necessary frequencies of light. These are used to work with the lights or light pairs, arranged to ensure complete cure of an object. Polymerization, in particular acrylate double bond conversion and induction period, can be affected by the choice of oligomers, photoinitiators, inhibitors, and pigments, as well as UV lamp irradiance and spectral output. In comparison to clear coat formulations, the presence of pigments may make curing much more complex due to the absorption of the UV radiation by the pigment. Thus, the use of variable wavelength UV sources, along with matching of absorption characteristics of photoinitiators with UV source spectral output, allows for curing of pigmented formulations.

Light sources used for UV curing include arc lamps, such as carbon arc lamps, xenon arc lamps, mercury vapor lamps, tungsten halide lamps, lasers, the sun, sunlamps, and fluorescent lamps with ultra-violet light emitting phosphors. Medium pressure mercury and high pressure xenon lamps have various emission lines at wavelengths which are absorbed by most commercially available photoinitiators. In addition, mercury arc lamps can be doped with iron or gallium. Alternatively, lasers are monochromatic (single wavelength) and can be used to excite photoinitiators which absorb at wavelengths that are too weak or not available when using arc lamps. For instance, medium pressure mercury arc lamps have intense emission lines at 254 nm, 265 nm, 295 nm, 301 nm, 313 nm, 366 nm, 405/408 nm, 436 nm, 546 nm, and 577/579 nm. Therefore, a photoinitiator with an absorbance maximum at 350 nm may not be a efficiently excited using a medium pressure mercury arc lamp, but could be efficiently initiated using a 355 nm Nd:YVO4 (Vanadate) solid-state lasers. Commercial UV/Visible light sources with varied spectral output in the range of 250-450 nm may be used directly for curing purposes; however wavelength selection can be achieved with the use of optical bandpass or longpass filters. Therefore, as described herein, the user can take advantage of the optimal photoinitiator absorbance characteristics.

Regardless of the light source, the emission spectra of the lamp must overlap the absorbance spectrum of the photoinitiator. Two aspects of the photoinitator absorbance spectrum need to be considered. The wavelength absorbed and the strength of absorption (molar extinction coefficient). By way of example only, the photoinitiators HMPP (2-hydroxy-2-methyl-1-phenyl-propan-1-one) and TPO (diphenyl(2,4,6-trimethylbenzoyl) phosphine oxide) in DAROCUR® 4265 (from Ciba Specialty Chemicals 540 White Plains Road, Tarrytown, N.Y., U.S.A.) have absorbance peaks at 270-290 nm and 360-380 nm, while DAROCUR® 1173 (from Ciba Specialty Chemicals 540 White Plains Road, Tarrytown, N.Y., U.S.A.) have absorbance peaks at 245 nm, 280 nm, and 331 nm, while ESACURE® KTO-46 (from Lamberti S.p.A., Gallarate (VA), Italy) have absorbance peaks between 245 nm and 378 nm, and MMMP in IRGACURE® 907 (from Ciba Specialty Chemicals 540 White Plains Road, Tarrytown, N.Y., U.S.A.) absorbs at 350 nm and IRGACURE® 500 (which is a blend of IRGACURE® 184 (from Ciba Specialty Chemicals 540 White Plains Road, Tarrytown, N.Y., U.S.A.) and benzophenone) absorbs between 300 nm and 450 nm.

The addition of pigment to a formulation increases the opacity of the resulting coating and can affect any through curing abilities. Furthermore, the added pigment can absorb the incident curing radiation and thereby affect the performance of the photoinitiator. Thus, the curing properties of opaque pigmented coatings can depend on the pigment present, individual formulation, irradiation conditions, and substrate reflection. Therefore consideration of the respective UV/Vis absorbance characteristics of the pigment and the photoinitiator can be used to optimize UV curing of pigmented coatings. Generally, photoinitiators used for curing pigmented formulations have a higher molar extinction coefficient between the longer wavelengths (300 nm-450 nm) than those used for curing clear formulations. Although, the presence of pigments can absorb radiation both in the UV and visible light regions, thereby reducing absorption suitable for radiation curing, phosphine oxide type photoinitiators, for example but not limited to bis acylphosphine oxide, are effective in pigmented, including, by way of example only, black, UV-curable coating materials. Phosphine oxides also find use as photoinitiators for white coatings, and enable an effective through cure for the compositions described herein.

The mercury gas discharge lamp is the UV source most widely used for curing, as it is a very efficient lamp with intense lines UV-C (200-280 nm) radiation, however it has spectral emission lines in the UV-A (315-400 nm) and in the UV-B (280-513 nm) regions. The mercury pressure strongly affects the spectral efficiency of this lamp in the UV-A, UV-B and UV-C regions. Furthermore, by adding small amounts (doping) of silver, gallium, indium, lead, antimony, bismuth, manganese, iron, cobalt and/or nickel to the mercury as metal iodides or bromides, the mercury spectrum can be strongly changed mainly in the UV-A, but also in the UV-B and UV-C regions. Doped gallium gives intensive lines at 403 and 417 nm; whereas doping with iron raises the spectral radiant power in the UV-A region of 358-388 nm by a factor of 2, while because of the presence of iodides UV-B and UV-C radiation are decreased by a factor of 3 to 7. As discussed above, the presence of pigments in a coating formulation can absorb incident radiation and thereby affect the excitation of the photoinitiator. Thus, it is desirable to tailor the UV source used with the pigment dispersions and the photoinitiator, photoinitiator mixture or photoinitiator/co-initiator mixture used. For instance, by way of example only, an iron doped mercury arc lamp (emission 358-388 nm) is ideal for use with photoinitiator ESACURE® KTO-46 (from Lamberti S.p.A., Gallarate (VA), Italy) (absorbance between 245 and 378 nm).

Multiple lamps with a different spectral characteristics, or sufficiently different in that there is some spectral overlap, can be used to excite mixtures of photoinitiator or mixtures of photoinitatiors and co-initiators. For instance, by way of example only, the use of a iron doped mercury arc lamp (emission 358-388 nm) in combination with a pure mercury arc lamp (emission 200-280 nm). The order in which the excitation sources are applied can be adventitiously used to obtain enhanced coating characteristic, such as, by way of example only, smoothness, matt, adhesion, abrasion resistance and corrosion resistance. Initial exposure of the coated surface with the longer wavelength source is beneficial, as it traps the filler particle in place and initiates polymerization near the surface, thereby imparting a smooth and adherent coating. Following this with exposure to the higher energy, shorter wavelength radiation enables for a fast cure of the remaining film that has been set in place by the initial polymerization stage.

The time of exposure to each lamp type can be manipulated to enhance the curing of the compositions described herein. One approach used for curing of the compositions described herein used to coat surfaces of flexible objects or objects comprising angular features, is to expose the coated surface to the longer wavelength doped mercury arc lamps for a shorter time than exposure to the shorter wavelength mercury arc lamp. However, this exposure scheme may cause the cured coatings to wrinkle/crinkle. Therefore, other exposure schemes involve identical exposure time for both the short wavelength mercury arc lamp, and the longer wavelength doped mercury arc lamps, or alternatively the exposure time to the longer wavelength doped mercury arc lamp can be longer than the time of exposure for the short wavelength mercury arc lamps.

### EXAMPLES

### Example 1

### Formulation for Monomer Matt Additive

An embodiment of a monomer matt additive is prepared by adding 20 wt-% of Nan-O-Sil Colloidal Silica to 80 wt-% of isobornyl acrylate. The mixing vessel containing the resulting mixture is immersed in the water bath of a sonic cleaner and sonicated for approximately 10 minutes, following by mixing, with a helical mixture, for approximately 10 minutes. This mixing cycle is repeated 5 times to produce a homogenous material suitable for use in any actinic-radiation curable substantially all solids coating composition comprising isobornyl acrylate.

### Example 2

### Formulation for Monomer Matt Additive

An embodiment of a monomer matt additive is prepared by adding 30 wt-% of Nan-O-Sil Colloidal Silica to 70 wt-% of butanediol acrylate. The mixing vessel containing the resulting mixture is immersed in the water bath of a sonic cleaner and sonicated for approximately 8 minutes, following by mixing, with a helical mixture, for approximately 10 minutes. This mixing cycle is repeated 4 times to produce a homogenous material suitable for use in any actinic-radiation curable substantially all solids coating composition comprising butanediol acrylate.

### Example 3

### Formulation for Coating Providing a Matt Finish Upon Curing

An embodiment for a coating composition to yield a matt finish flexible coating with excellent abrasion resistance, scratch resistance, corrosion resistance and adhesion properties is prepared by mixing, with a helical mixer, 25.683% of an aliphatic urethane triacrylate (EBECRYL® 264, from UCB Surface Specialties, Brussels, Belgium), 18.032% 2-phenoxyethyl acrylate, 26.229% of the isobornyl acrylate matt additive (see Example 1), 8.743% methacrylate ester derivative adhesion promoter (EBECRYL® 168, from UCB Surface Specialties, Brussels, Belgium), 14.210% of propoxylated glyceryl triacrylate-nano-silica (Nanocryl® C-155, formerly Nanocryl®XP 21 0953, from hanse chemie AG, Geesthacht, Germany), 5.464% of DARACUR® 1173 (from Ciba Specialty Chemicals 540 White Plains Road, Tarrytown, N.Y., U.S.A.), and 1.639% of ESACURE® KTO-46 (from Lamberti S.p.A., Gallarate (VA), Italy). These components are thoroughly mixed by the helical mixer until a smooth composition is produced. This composition is applied by HVLP and cured by UV light.

To 94.43% of this clear coat composition is added 3.60% carbon black bonded to a modified acrylic (solid pigment dispersions, PC 9317 from Elementis, Staines, UK), and 2.06% synthetic amorphous silica with organic surface treatment (SYLOID® RAD 221, from the Grace Davison division of WR Grace & Co., Columbia, Md., U.S.A.). These additions are dispersed throughout the clear coating by a helical mixer until a smooth black coating composition is produced which may be applied by HVLP and cured by UV light.

While the invention has been described in connection with certain embodiments, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An additive for actinic radiation curable, substantially all solids compositions providing a matt finish upon curing comprising a dispersion of about 10 wt-% to about 40 wt-% of amorphous silica and at least one monomer, wherein the dispersion has essentially no solvent and is formed by at least one mixing cycle comprising an ultrasonic mixing step and a mechanical mixing step.

2. The additive of claim 1 wherein the at least one mixing cycle is a first ultrasonic mixing step and a second mechanical mixing step.

3. The additive of claim 1 wherein the at least one mixing cycle is a first mechanical mixing step and a second ultrasonic mixing step.

4. The additive of claim 1 comprising at least four mixing cycles.

5. The additive of claim 1 wherein each ultrasonic mixing step lasts at least about 1 minute, and each mechanical mixing step lasts at least about 1 minute.

6. The additive of claim 1 wherein each ultrasonic mixing step lasts less than about 30 minutes and each mechanical mixing step lasts less than about 30 minutes.

7. The additive of claim 1 wherein the at least one monomer is selected from a group consisting of an isobornyl acrylate, a tetrahydrofurfuryl acrylate, butanediol acrylate, 2-phenoxyethyl acrylate, a propoxylated glyceral triacrylate, a 1,6-hexanediol diacrylate, a dipropylene glycol diacrylate, a tripropylene glycol diacrylate, a neopentyl glycol propoxylated diacrylate, a trimethylopropane triacrylate, a trimethylopropane ethoxylate triacrylate, a pentaerythritol alkoxylate tetraacrylate, a dimethylopropane tetraacrylate, and combinations thereof.

8. The additive of claim 1, wherein the amorphous silica is selected from colloidal silica, powdered silica, fumed amorphous silica, fused amorphous silica, gelled amorphous silica or precipitated amorphous silica.

9. The additive of claim 8, wherein the average size of the amorphous silica is less than 1 micron.

10. The additive of claim 1, wherein the room temperature viscosity of the disperson is less than about 500 centipoise

11. An actinic radiation curable, substantially all solids composition providing a matt finish upon curing comprising the additive of claim 1, at least one oligomer, at least one photoinitiator, and at least one nano-filler.

12. An actinic radiation curable, substantially all solids composition providing a matt finish upon curing comprising the additive of claim 1, at least one oligomer, at least one photoinitatior, at least one co-photoinitiator, at least one filler, and at least one polymerizable pigment dispersion.

13. An actinic radiation curable, substantially all solids composition providing a matt finish upon curing comprising the additive of claim 1, at least one oligomer, at least one photoinitiator, at least one surfactant, and at least one nano-filler.

14. The composition of any of claim 11, 12, or 13, wherein the room temperature viscosity is less than about 500 centipoise.

15. The composition of claim 11, wherein the composition is added to a coating to coat at least a portion of a surface of a metal object, a wood object, a plastic object, or a composite object.

16. The composition in claim 15, wherein the resulting uncured coating has been applied to the surface by an electrostatic spraying apparatus.

17. A completely cured coated surface prepared by exposing the uncured coated surface of claim 16 to actinic radiation.

18. The completely cured coated surface of claim 17, wherein the actinic radiation is ultra-violet (UV) radiation selected from the group consisting of UV-A radiation, UV-B radiation, UV-C radiation, UV-D radiation, or combinations thereof.

19. An article of manufacture comprising the completely cured coated surface of claim 18, wherein the coating has a matt finish.

20. A method for forming a monomer matt additive comprising mixing about 10 wt-% to about 40 wt-% of amorphous silica in a monomer, wherein the mixing comprises at least one ultrasonic mixing step and at least one mechanical mixing step, and wherein the resulting dispersion has a room temperature viscosity less than about 500 centipoise.

21. A method for forming an actinic radiation curable, substantially all solids composition providing a matt finish upon curing comprising substituting the monomer matt additive of claim 20 for a monomer in a formulation for an actinic radiation curable, substantially all solids composition.

22. The method of claim 21, wherein the wt-% of the substituted monomer matt additive is essentially the same as the wt-% of the replaced monomer.
